(19) United States
(12) Patent Application Publication
(10) Pub. No.: US 2025/0055997 A1
(43) Pub. Date: Feb. 13, 2025

(54) METHOD AND APPARATUS FOR VIDEO ENCODING AND DECODING WITH ADAPTIVE DEPENDENT QUANTIZATION

(71) Applicant: InterDigital CE Patent Holdings, SAS, Paris (FR)

(72) Inventors: Ya Chen, Rennes (FR); Franck Galpin, Thorigne-Fouillard (FR); Edouard Francois, Bourg des Comptes (FR); Philippe De Lagrange, Betton (FR)

(21) Appl. No.: 18/719,631

(22) PCT Filed: Dec. 16, 2022
(86) PCT No.: PCT/EP2022/086284

§ 371 Date: Jun. 13, 2024

(30) Foreign Application Priority Data
Dec. 21, 2021 (EP) 21306890.1

(51) Int. Cl. H04N 19/124; H04N 19/159; H04N 19/176

(52) U.S. Cl. CPC H04N 19/124; H04N 19/159; H04N 19/176

(57) ABSTRACT

At least a method and an apparatus are presented for efficiently encoding or decoding video. For example, a number of states used in a dependent quantization DQ is determined for a transform block; and the DQ/inverse DQ with the determined number of states is applied to the transform block. According to non-limiting examples, the usage of DQ and the number of states used for DQ is based on the number of coded coefficients in the transform block, the transform block size, the prediction mode (intra/inter) of the block, the color components (luma/chroma), the quantization parameter of the block, the transforms type.

### CROSS REFERENCE TO RELATED APPLICATIONS

This application claims the benefit of European Patent Application No. 21306890.1, filed on Dec. 21, 2021, which is incorporated herein by reference in its entirety.

### TECHNICAL FIELD

At least one of the present embodiments generally relates to a method or an apparatus for video encoding or decoding, and more particularly, to a method or an apparatus comprising determining a number of states used in a dependent quantization DQ for a transform block; and applying the DQ/inverse DQ with the determined number of states to the transform block.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

Existing methods for coding and decoding show some limitations in supporting various state machines to switch between the two scalar quantizers in a dependent quantization scheme. For instance, in current design, the number of states is fixed and set to 4 or 8. Therefore, there is a need to improve the compression efficiency with regard to state of the art, that is, to reduce the bitrate while maintaining the quality, or equivalently to improve the quality while maintaining the bitrate. Another intent is to reduce average complexity.

### SUMMARY

The drawbacks and disadvantages of the prior art are solved and addressed by the general aspects described herein.

According to a first aspect, there is provided a method. The method comprises video decoding by determining a number of states used in a dependent quantization for a block of quantized coefficients; and obtaining a block of coefficients by applying an inverse dependent quantization with the determined number of states to the block of quantized coefficients.

According to another aspect, there is provided a second method. The method comprises video encoding by determining a number of states used in a dependent quantization for a block of coefficients; and obtaining a block of quantized coefficients by applying the dependent quantization with the determined number of states to the block of coefficients.

According to another aspect, there is provided an apparatus. The apparatus comprises one or more processors, wherein the one or more processors are configured to implement the method for video decoding according to any of its variants. According to another aspect, the apparatus for video decoding comprises means for determining a number of states used in a dependent quantization for a block of quantized coefficients; and means for obtaining a block of coefficients by applying an inverse dependent quantization with the determined number of states to the block of quantized coefficients.

According to another aspect, there is provided another apparatus. The apparatus comprises one or more processors, wherein the one or more processors are configured to implement the method for video encoding according to any of its variants. According to another aspect, the apparatus for video encoding comprises means for determining a number of states used in a dependent quantization for a block of coefficients; and means for obtaining a block of quantized coefficients by applying the dependent quantization with the determined number of states to the block of coefficients.

According to another general aspect of at least one embodiment, the number of states used in the dependent quantization is one of 1, 4 or 2K with K being a positive integer larger than 2 and with a one state quantization refers to independent scalar quantization.

According to another general aspect of at least one embodiment, the method further comprises determining an indicator of a number of coded coefficients in the block of coefficients; and determining the number of states used in the dependent quantization based on whether the number of coded coefficients in the block of coefficients is higher than a value. According to another general aspect of at least one embodiment, an indicator of a number of coded coefficients in the block of coefficients is determined based on an indicator of a scan position of the last significant coefficient.

According to another general aspect of at least one embodiment, the number of states used in the dependent quantization based on at least one of a size, a width, a height of the block of coefficients; a prediction mode intra/inter; an intra coding mode; an inter coding mode; a color component index; a quantization parameter; a type of transform; or a size of transform.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of the video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described encoding/decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

In the drawings, examples of several embodiments are illustrated.

FIG. 1 illustrates a block diagram of an example apparatus in which various aspects of the embodiments may be implemented.

FIG. 2 illustrates a block diagram of an embodiment of video encoder in which various aspects of the embodiments may be implemented.

FIG. 3 illustrates a block diagram of an embodiment of video decoder in which various aspects of the embodiments may be implemented.

FIG. 4 illustrates a dependent quantization process using two scalar quantizers.

FIG. 5 illustrates a 4-state based quantizer selection process as for instance used in VVC.

FIG. 6 illustrates paths through the trellis graph in 4-state based DQ as for instance used in VVC.

FIG. 7 illustrates paths through the trellis graph in 8-state based DQ as for instance used in ECM.

FIG. 8 illustrates a generic decoding method according to a general aspect of at least one embodiment.

FIG. 9 illustrates a generic encoding method according to a general aspect of at least one embodiment.

FIG. 10 illustrates a decoding method according to a general aspect of a specific embodiment.

### DETAILED DESCRIPTION

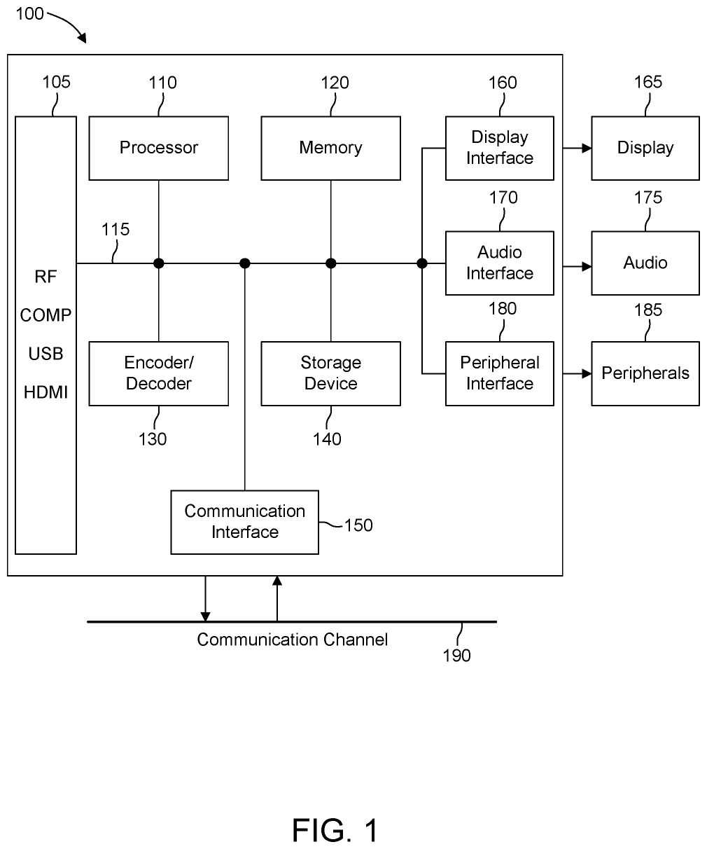

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g. a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

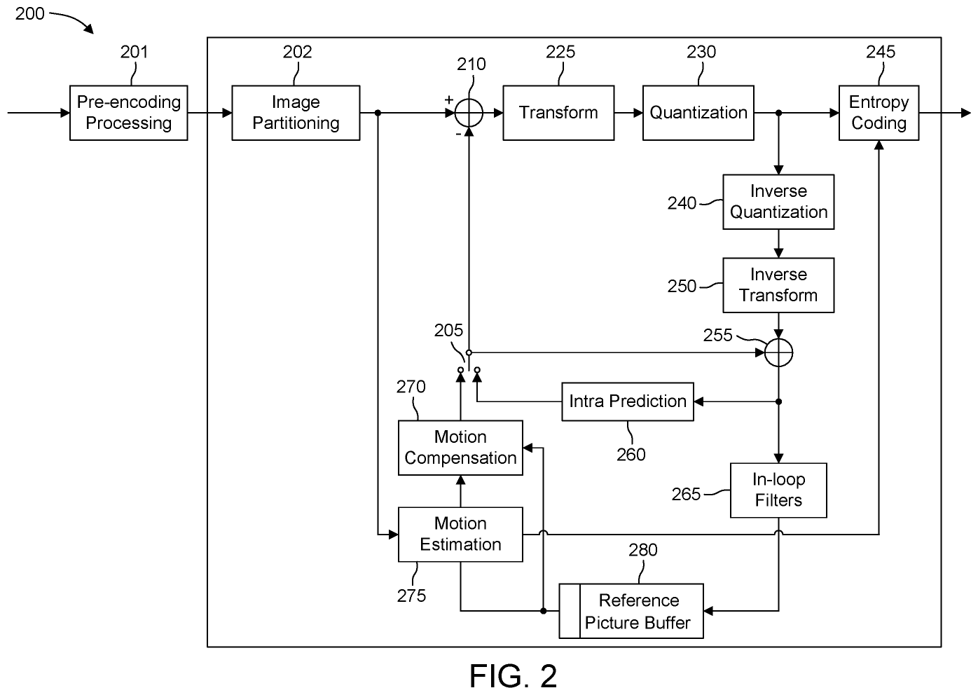

FIG. 2 illustrates an example video encoder 200, such as a VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

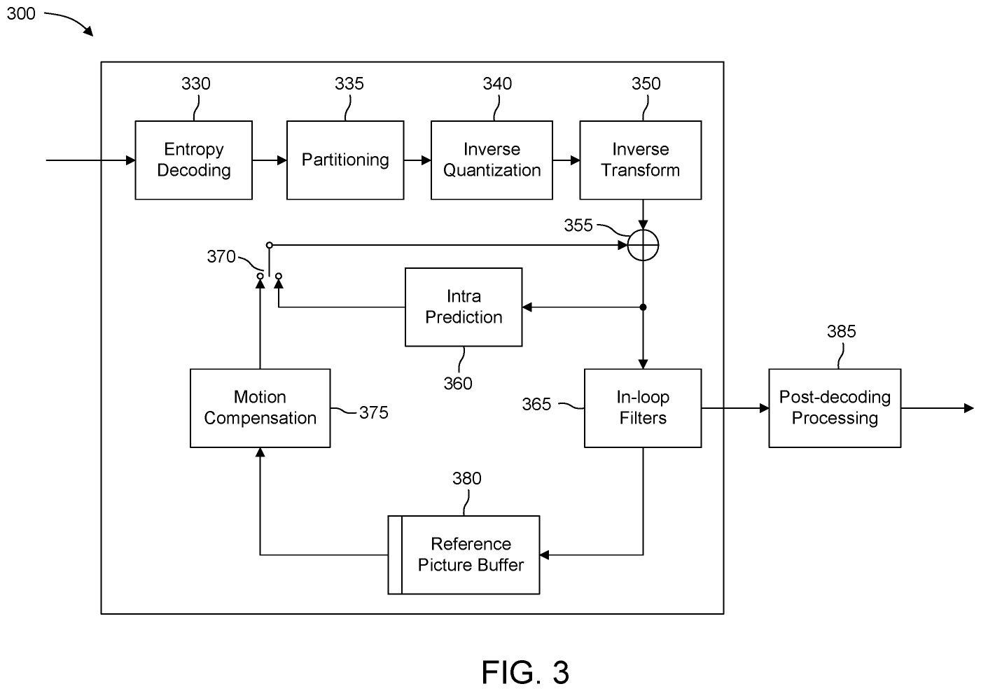

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

The High Efficiency Video Coding (HEVC) standard specifies conventional independent scalar quantization with Uniform Reconstruction Quantizers (URQs). The reconstructed transform coefficients of URQs are completely denoted by integer multiples of a quantization step size Δ. This integer specifies the associated transform coefficient level, which is transmitted as quantization indexes q. The mapping of quantization indexes q to reconstructed transform coefficients t′ is given by the simple relationship:

$${t}^{′} = q \times Δ . \qquad ( 1 )$$

For maximizing the coding efficiency, the encoder should select the quantization indexes q that minimize a Lagrangian cost function:

$$J = D + λ R \qquad ( 2 )$$

where D represents the distortion and R is the number of bits that are required for transmitting the quantization indexes q; the Lagrange multiplier λ is typically chosen based on the quantization step size Δ.

In the reference encoders for the HEVC, Rate-Distortion Optimized Quantization (RDOQ) algorithm is used for selecting the quantization indexes q. It takes the dependencies between quantization indexes q that are caused by the entropy coding into account.

While conventional independent scalar quantization maps one transform coefficient into one quantization index once, and the set of reconstructed transform coefficients constitutes an orthogonal lattice in the N-dimensional space (N represents the number of coded transform coefficients in a transform block). It causes an unavoidable loss in coding efficiency relative to the fundamental rate-distortion bound.

This gap can only be reduced by applying some form of vector quantization. However, unconstrained vector quantization is too complex for the area of video coding, there are some variants with reasonable encoder and decoder complexity. The HEVC already includes a coding tool, called Sign Data Hiding (SDH), which can be interpreted as a very simple type of vector quantization.

In quantization process of the Versatile Video Coding (VVC) and of the Exploratory Coding Model (ECM), Dependent Quantization (DQ), also referred to as Trellis-Coded Quantization (TCQ), replaces conventional independent scalar quantization and the RDOQ to select the quantization indexes in the encoder as used in the HEVC. DQ refers to an approach in which the set of available reconstruction values for a transform coefficient depends on the values of the transform coefficient levels that precede the current transform coefficient level in reconstruction order.

From a decoder point of view, it specifies two quantizers and a procedure for switching between them. Commonly, the available reconstruction values are denoted by integer multiples of a quantization step size Δ for both scalar quantizers. One quantizer includes the even and the other the odd multiples of Δ. The switching between the two scalar quantizers can be described by a state machine with 2^{K} states (K≥2), where each state is associated with one of the scalar quantizers. The current state and, thus, the quantizer used for a current transform coefficient is uniquely determined by the previous state and the value of the previous quantization index. For encoding, the potential transitions between the two scalar quantizers can be represented by a trellis with 2^{K} states per sample. Selecting the optimal sequence of quantization indexes is equivalent to finding the trellis path with minimum rate-distortion cost. The optimal solution can be found by the Viterbi algorithm.

DQ can be considered as a vector quantizer for very large dimensions, but with a restricted set of values for the vector components. In DQ, the available reconstruction vectors are packed denser in the N-dimensional vector space, which provides a part of the space-filling advantage of vector quantization. That means, for a given average number of available reconstruction vectors per N-dimensional unit volume, the average distortion between an input vector and the closest reconstruction vector is reduced compared to the conventional scalar quantization.

The packing density in the high-dimensional signal space, and thus the coding efficiency, for long sample sequences is maximized by choosing the state transitions (state machine) properly. Furthermore, the achievable packing density, but also the encoding complexity, increases with the number of states.

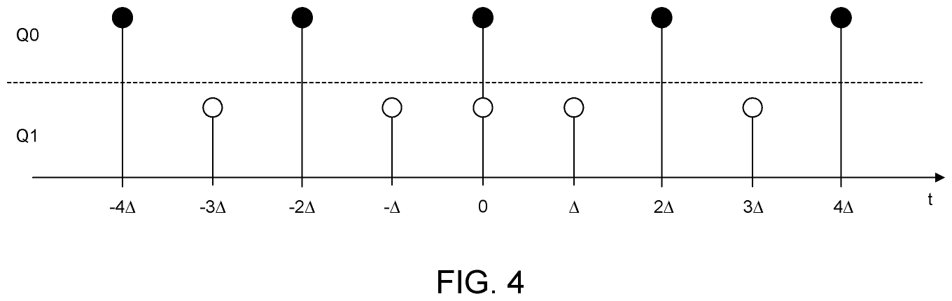

FIG. 4 illustrates a dependent quantization process with two scalar quantizers noted Q₀ and Q₁. The reconstruction values for Q₀ (filled circles) are given by the even multiples of the quantization step size Δ; the reconstruction values for Q₁ (hollow circles) are given by the odd multiples of Δ and, in addition, the value of zero. The scalar quantizer used (Q₀ or Q₁) is not explicitly signaled in the bitstream. Instead, the quantizer used for a current transform coefficient is selected by a state machine.

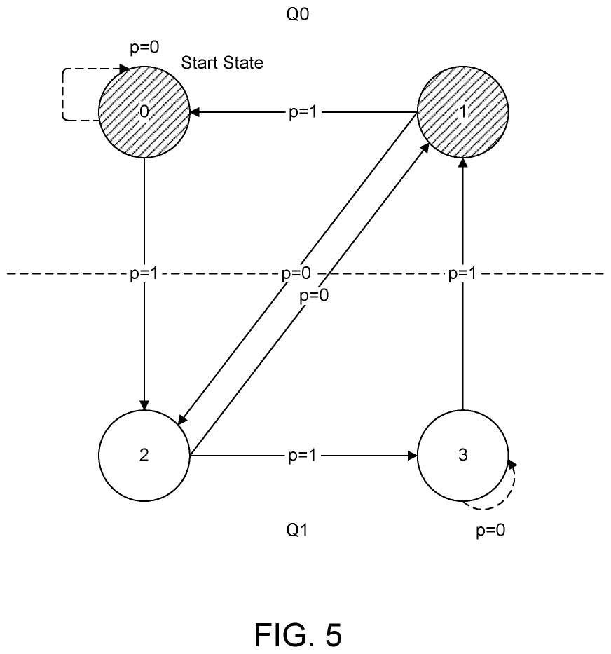

In VVC, the simplest DQ design with 4 states is chosen, which also helps to keep the encoder complexity as low as possible. FIG. 5 illustrates a 4-state based quantizer selection process as used in VVC. The transform coefficients of a block have to be reconstructed in a pre-defined order, which shall be indicated by the indexes n=0, 1, . . . , N−1. The initial state s₀ (for the first transform coefficient t₀ in coding order) is set equal to 0. Then, given a current state sₙ and the value of the current quantization index qₙ, the next state sₙ+1 is uniquely determined by the current state sₙ and the parity pₙ of the current quantization index qₙ. As shown in Table 1, for transform coefficients tₙ with associated states sₙ equal to 0 or 1, the quantizer Q₀ is used; and for transform coefficients tₙ with states sₙ equal to 2 or 3, the quantizer Q₁ is used. Table 1 can be represented as a following 2-D array state transition table:

$$4 stateTransTable [ \cdot ] [ \cdot ] = \{ \{ 0 , 2 \} , \{ 2 , 0 \} , \{ 1 , 3 \} , \{ 3 , 1 \} \} . \qquad ( 3 )$$

TABLE 1
4-state transitions for quantizer selection.
pₙ represents the parity of the
current quantizer index qₙ.

| state | quantizer | next state sₙ₊₁ | |
|---|---|---|---|
| sₙ | used | pₙ = 0 | pₙ = 1 |
| 0 | Q₀ | 0 | 2 |
| 1 | Q₀ | 2 | 0 |
| 2 | Q₁ | 1 | 3 |
| 3 | Q₁ | 3 | 1 |

```
sₙ = 0
for n = 0 to N − 1 do (4)
  t′ₙ = (2 × qₙ − (sₙ >> 1) × sgn(qₙ)) × Δ
    sₙ₊₁ = 4stateTransTable[sₙ][qₙ & 1]
end for
```

Given the N quantization indexes qₙ of a block, with n indicating the coding order, the associated reconstructed transform coefficients t′ₙ can be obtained by the following simple pseudo code:
where sgn(·) specifies the signum function, A denotes the quantization step size; the operator “»” specifies a bit shift to the right, so that (sₙ »1) indicates the quantizer used; the parity pₙ of the quantization index qₙ can be obtained by applying the bit-wise “AND” operator & (two's complement arithmetic) according to qₙ & 1.

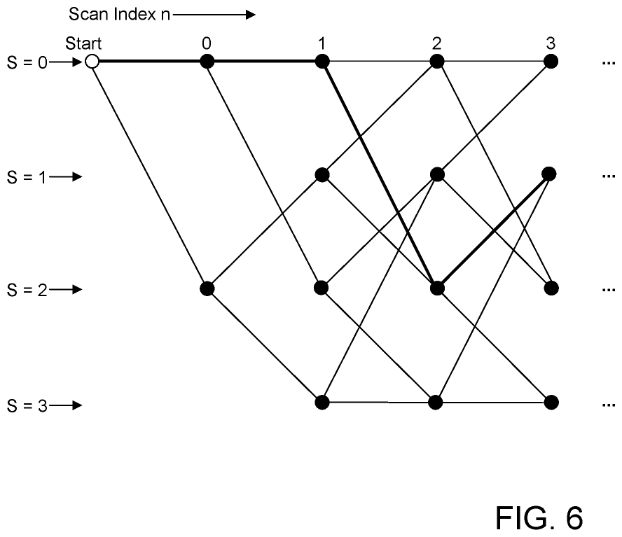

FIG. 6 illustrates a path through the trellis graph in DQ with 4 states. The selection of quantization indexes qₙ in the encoder aims at minimizing the rate-distortion cost, which is equivalent to finding the path through the trellis graph in DQ, depicted in FIG. 6, as given by the Viterbi algorithm. The trellis is processed in coding order, all possible transitions (connections of the trellis nodes) between a scan index n−1 and a next scan index n are evaluated, for each destination node, only the connection with the minimum rate-distortion cost Jₙ is kept and the associated cost Jₙ is assigned to the destination node. This process is continued until n=N−1, where 4 surviving paths through the trellis are obtained. At the end, the path with the minimum cost J_{N-1} is selected, which eventually provides the selected sequence of quantization indexes n=q₀, q₁, . . . , q_{N-1}. An exemplary path with minimum cost is highlighted as bold line in FIG. 6.

As noted above, the coding efficiency of trellis-coded quantization in VVC increased by increasing the number of quantization states (at the cost of a higher encoder complexity). DQ with 8 quantization states in addition to the current variant of DQ with 4 quantization state is supported in ECM.

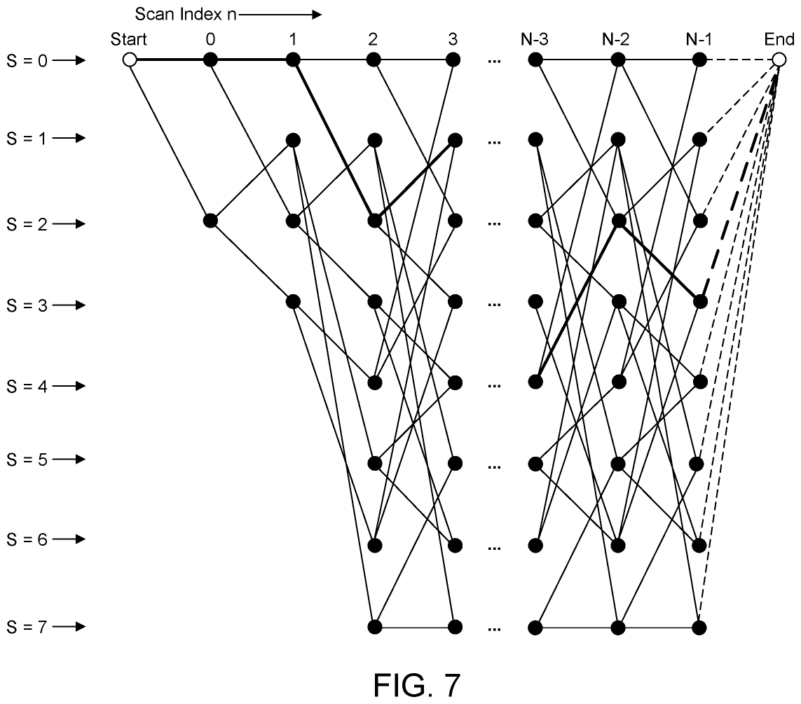

FIG. 7 illustrated paths through the trellis graph in 8-state based DQ. The 8-state based quantizer selection process is illustrated in Table 2, for transform coefficients tₙ with associated even states sₙ (which equal to 0, 2, 4 or 6), the quantizer Q₀ is used; and for transform coefficients tₙ with odd states sₙ (which equal to 1, 3, 5 or 7), the quantizer Q₁ is used. The associated 2-D array state transition table can be represented as:

$$8 stateTransTable [ \cdot ] [ \cdot ] = \{ \{ 0 , 2 \} , \{ 5 , 7 \} , \{ 1 , 3 \} , \{ 6 , 4 \} , \{ 2 , 0 \} , \{ 4 , 6 \} , \{ 3 , 1 \} , \{ 7 , 5 \} \} . \qquad ( 5 )$$

TABLE 2
8-state transitions for quantizer selection.

| state | quantizer | next state sₙ₊₁ | |
|---|---|---|---|
| sₙ | used | pₙ = 0 | pₙ = 1 |
| 0 | Q₀ | 0 | 2 |
| 1 | Q₁ | 5 | 7 |
| 2 | Q₀ | 1 | 3 |
| 3 | Q₁ | 6 | 4 |
| 4 | Q₀ | 2 | 0 |
| 5 | Q₁ | 4 | 6 |
| 6 | Q₀ | 3 | 1 |
| 7 | Q₁ | 7 | 5 |

When DQ with 8 quantization states is applied, it yields 8 surviving paths through the trellis for determining the quantization indexes in the encoder, as depicted in FIG. 7. As the number of trellis states is increased, the achievable packing density in the signal space is increased, which results in the improvement of the coding efficiency. While at the same time, the number of surviving paths comparations is increased, which results in the increasement of the computational burdens.

For supporting both variants of dependent quantization (4 and 8 states) in a unified framework, the decoding process for the VVC variant of dependent quantization is re-written in ECM. The state transition table in Equation (3) is modified as:

$$4 stateTransTable [ \cdot ] [ \cdot ] = \{ \{ 0 , 1 \} , \{ 2 , 3 \} , \{ 1 , 0 \} , \{ 3 , 2 \} \} . \qquad ( 6 )$$

The mapping of reconstructed transform coefficients t′n from quantization indexes qₙ in Equation (4) is modified as:

$${t}_{n}^{′} = ( 2 \times {q}_{n} - ( {s}_{n} \& 1 ) \times sgn ( {q}_{n} ) ) \times Δ . \qquad ( 7 )$$

Besides the mapping of transform coefficients level to intermediate quantization indexes, two more aspects for efficient entropy coding that depend on the quantization state s have also been re-written in ECM. Each quantization index q is mapped to a sequence of bins, which are coded using the context-based adaptive binary arithmetic coding (CABAC) engine. There two classes of bins: bins that are coded using adaptive probability models (i.e., in the regular mode of the coding engine) and bins that are transmitted in the bypass mode of the arithmetic coding engine. An absolute quantization index |q| is mapped into the bins: sig, gt1, par, gt3, and the non-binary syntax element rem. At the decoder side, |q| is constructed according to:

$$\vert q \vert = sig + gt 1 + p a r + 2 \times ( g t 3 + r em ) . \qquad ( 8 )$$

The bins sig, gt1, par and gt3 are coded in the regular mode of the CABAC engine. The non-binary syntax element rem is binarized using Golomb-Rice and Exp-Golomb codes and the resulting bins are coded in bypass mode. The binarization is parameterized by a so-called Rice parameter. The quantization state s is applied on the context selection for sig, and the related derivation is re-written as:

$$sig\_ctxSet [ s \& 3 ] = \{ 0 , 1 , 0 , 2 \} . \qquad ( 9 )$$

Another usage of quantization state s is the derivation of the mapping parameter ZeroPos for transform coefficient levels coded in bypass mode, which is re-written as:

$$ZeroPos = ( 1 + ( s \& 1 ) ) ≪ rice parameter \qquad ( 10 )$$

where the operator “«” specifies a bit shift to the left.

Therefore, the decoding process is designed in a way that only the state transition table used depends on the selected variant of dependent quantization; other remaining aspects are the same for both 4-state and 8-state versions of dependent quantization.

The used variant of DQ is indicated in the picture header (PH) or the picture parameter set (PPS). For that purpose, as shown in Table 3b, the PH syntax element pic_dep_quant_enabled_flag of original table 3a is replaced by the syntax element pic_dep_quant_enabled_idc, which is coded using 2 bits in table 3b.

TABLE 3a
Original picture header or the picture parameter set.

| | |
|---|---|
| ... | |
| if ( !pps_dep_quant_enabled_idc ) | |
| pic_dep_quant_enabled_flag | u(1) |
| ... | |

TABLE 3b
The used variant of dependent quantization
is indicated in the picture header or
the picture parameter set.

| | |
|---|---|
| ... | |
| if ( !pps_dep_quant_enabled_idc ) | |
| pic_dep_quant_enabled_idc | u(2) |
| ... | |

As depicted in Table 4b, the selection of the state transition table for a transform block would depend on pic_dep_quant_enabled_idc. pic_dep_quant_enabled_idc equal to 0 specifies that dependent quantization is disabled for slices associated with the PH. pic_dep_quant_enabled_idc equal to 1 specifies that dependent quantization with 4 states is used in slices associated with the PH, where the 2D-array 4stateTransTable in Equation (6) is used. pic_dep_quant_enabled_flag equal to 2 specifies that dependent quantization with 8 states is used in slices associated with the PH, where the 2D-array 8stateTransTable in Equation (5) is used.

TABLE 4a
Original selection of dependent quantization.

| | Descriptor |
|---|---|
| residual_coding( x0, y0, log2TbWidth, log2TbHeight, cldx ) { | |
| ... | |
| state Tab = pic_dep_quant_enabled_flag > 0 ? 4stateTransTable : 0 | |
| ... | |

TABLE 4b
The used variant of the state transition table for a transform
block is decided by pic_dep_quant_enabled_idc.

| | Descriptor |
|---|---|
| residual_coding( x0, y0, log2TbWidth, log2TbHeight, cldx ) { | |
| ... | |
| stateTab = pic_dep_quant_enabled_idc > 0 ? ( | |
| pic_dep_quant_enabled_idc > 1 ? 8stateTransTable : 4stateTransTable ) : 0 | |
| ... | |

Thus, the achievable packing density of the trellis-coded quantization, but also the encoding complexity, increases with the number of states. For most transform blocks only containing a small number of reconstructed transform coefficients, the simplest DQ design with a low number of states (for example 4) provides a good trade-off between complexity and coding gain. For transform blocks with large number of transform coefficients, the packing density in such high-dimensional signal space could be achieved by DQ design with a larger number of states (for example 8 or even 2^{K}>8 states).

In the above described DQ design, the used variant of DQ with 4 states or 8 states is indicated in the slice/picture level. The selection of the state transition table for a transform block is decided by the PH syntax element pic_dep_quant_enabled_idc. The specific statistics of each transform block, i.e. the number of transform coefficients N in a transform block, are not taken into consideration for the number of states selection. It can be penalizing in terms of compression efficiency and complexity. It is thus desirable to enhance the coding efficiency or to reduce the coding complexity by choosing the state transitions for a transform block properly.

This is solved and addressed by the general aspects described herein, which are directed to extent and adapt the number of states used for a switch state machine in dependent quantization, the switch state machine achieving the switch between two scalar quantizers. Accordingly, at least one embodiment relates to adjust at the block level, the usage of DQ, and the number of states used for DQ based on:
1) the number of coded transform coefficients in the block,
2) the block size,
3) the prediction mode (intra/inter) of the block,
4) the color components (luma/chroma),
5) the quantization parameter (QP) of the block,
6) the transforms type, and/or any other features.

Alternatively, any combination of them may be applied.

At least some embodiments relate to method for encoding or decoding a video wherein the number of states used in a dependent quantization for a block of coefficients is determined and dependent quantization or inverse dependent quantization with the determined number of states is applied.

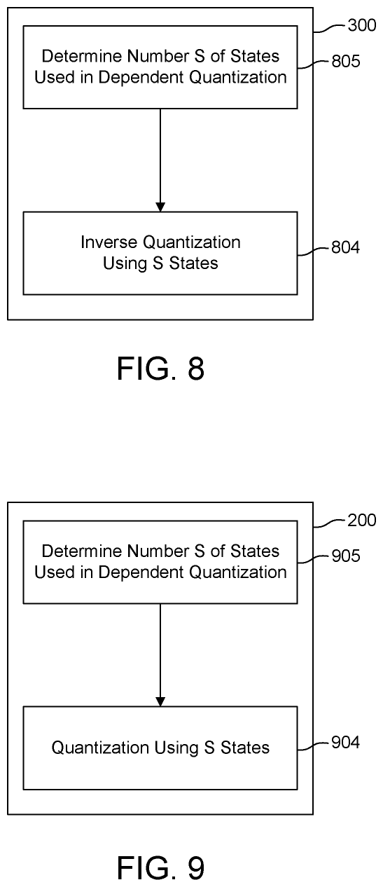

FIG. 8 illustrates a generic decoding method 300 according to a general aspect of at least one embodiment. The block diagram of FIG. 8 partially represents modules of a decoder or decoding method, for instance implemented in the exemplary decoder of FIG. 3.

According to a generic embodiment a method for decoding 300 is disclosed. The method comprises, determining 805, for a current block of quantized coefficients being decoded, a number of states to use in a dependent quantization for the current block. Advantageously, the number of states is adjusted at the block level. Thus, after determining 805 of the number of states for the current, the number of states is determined for another block, the number of states being different for different blocks. According to different embodiments, the number S of states used in dependent quantization is one of 1, 4, 8 or 16 as disclosed hereafter with detailed embodiments. More generally the number of states used in dependent quantization is a power K of 2, noted 2^{K}, K being a positive integer larger than one. The case with number of states being 1 (K=0) corresponds to scalar quantization, ie disabling dependent quantization since the state remains the same. According to a particular embodiment, the number of scalar quantizers used in dependent quantization is 2. According to various embodiments, the number of states is determined based on a number of coded coefficients in the current block, a size of the current block, a width of the current block, a height of the current block, a coding mode being intra or inter, an intra prediction mode, an inter coding mode, a color component index indicating whether the current block corresponds to a luma or a chroma component, a quantization parameter, a type of transform applied to the current block of quantized coefficients, or a size of transform. The various embodiments are detailed hereafter. The decoding 300 then further comprises for instance adapting the entropy decoding to the determined number of states and applying 804 an inverse dependent quantization with the determined number of states to the current block of quantized coefficients to obtain a block of coefficients. Then, decoding 300 then further comprises for instance performing the inverse transform of the block of coefficients, and adding the so-decoded residual values to a compensated prediction to decode the current block as in any regular decoder.

FIG. 9 illustrates a generic encoding method 200 according to a general aspect of at least one embodiment. The block diagram of FIG. 9 partially represents modules of an encoder or encoding method, for instance implemented in the exemplary encoder of FIG. 2.

The method for encoding 200 comprises, determining 905, for a current block of coefficients being encoded, a number of states to use in a dependent quantization for the current block. As for the decoding, the number S of states used in dependent quantization is one of 1, 4, 8 or 16 as disclosed hereafter with detailed embodiments. More generally the number of states used in dependent quantization is a power K of 2, noted 2^{K}, K being a positive integer larger than one. According to a particular embodiment, the number of scalar quantizers used in dependent quantization is 2. According to various embodiments, the number of states is determined based on a number of coefficients to code in the current block, a size of the current block, a width of the current block, a height of the current block, a coding mode being intra or inter, an intra prediction mode, an inter coding mode, a color component index indicating whether the current block corresponds to a luma or a chroma component, a quantization parameter, a type of transform applied to the current block of quantized coefficients, or a size of transform. The various embodiments are detailed hereafter. The encoding 200 then further comprises for instance adapting the entropy coding to the determined number of states.

Various embodiments of the generic encoding or decoding method are described in the following. As aforementioned, for a state machine to switch between the two scalar quantizers, rather than using fixed 4 states or 8 states in the slice/picture level, the number of states (including one state or more than 8 states) can be adjusted in the block level.

Firstly, among the various embodiments, the number of states used for DQ can be extended to more than 8. Next, the number of states used for DQ can be decided based on the number of coded transform coefficients in the transform block. Then, the number of states selection based on the block sizes is also described. Further, the impact of the block coded with intra/inter mode on the used variant of DQ decision is also described. Moreover, the color components (luma/chroma) are also the parameter to decide the number of states. Furthermore, the value of the quantization parameter (QP) used for the number of states selection is considered. At last, the transforms type could also be one feature to decide the number of states. Alternatively, any combination of them may be applied.

According to a first embodiment, DQ with larger than 8 states is disclosed. With the state-of-the-art principle of the DQ design described above, a state machine is applied to switch between the two scalar quantizers (Q₀ and Q₁), where each state is associated with one of the scalar quantizers. The current state and, thus, the quantizer used for a current sample are uniquely determined by the previous state and the value of the previous quantization index.

It is a well-known fact that the coding efficiency of trellis-coded quantization can be increased by increasing the number of states for the state machine (at the cost of a higher encoder complexity). Therefore, DQ with 8 states in addition to the variant of DQ with 4 quantization state is supported in ECM. To further improve the coding efficiency, DQ with larger than 8 states could be used in a particular embodiment.

For example, the 16-state based quantizer selection process could be illustrated in, such as, but not limited to Table 5. For transform coefficients ty with associated even states sₙ, the quantizer Q₀ is used; and for transform coefficients tₙ with odd states sₙ, the quantizer Q₁ is used. The associated 2-D array 16-state transition table can be represented as:

$$16 stateTransTable [ \cdot ] [ \cdot ] = \{ \{ 0 , 4 \} , \{ 2 , 6 \} , \{ 4 , 0 \} , \{ 8 , 12 \} , \{ 1 , 5 \} , \{ 9 , 13 \} , \{ 3 , 7 \} , \{ 11 , 15 \} , \{ 10 , 14 \} , \{ 6 , 2 \} , \{ 14 , 10 \} , \{ 12 , 8 \} , \{ 7 , 3 \} , \{ 5 , 1 \} , \{ 13 , 9 \} , \{ 15 , 11 \} \} . \qquad ( 11 )$$

TABLE 5
16-state transitions for quantizer selection.

| state | quantizer | next state sₙ₊₁ | |
|---|---|---|---|
| sₙ | used | pₙ = 0 | pₙ = 1 |
| 0 | Q₀ | 0 | 4 |
| 1 | Q₁ | 2 | 6 |
| 2 | Q₀ | 4 | 0 |
| 3 | Q₁ | 8 | 12 |
| 4 | Q₀ | 1 | 5 |
| 5 | Q₁ | 9 | 13 |
| 6 | Q₀ | 3 | 7 |
| 7 | Q₁ | 11 | 15 |
| 8 | Q₀ | 10 | 14 |
| 9 | Q₁ | 6 | 2 |
| 10 | Q₀ | 14 | 10 |
| 11 | Q₁ | 12 | 8 |
| 12 | Q₀ | 7 | 3 |
| 13 | Q₁ | 5 | 1 |
| 14 | Q₀ | 13 | 9 |
| 15 | Q₁ | 15 | 11 |

Alternatively, the state transition can also be specified in Equation (12) without a table look-up:

$${s}_{n + 1} = ( stateTransTab ≫ ( {s}_{n} ≪ 3 + ( {q}_{n} \& 1 ) ≪ 2 ) ) \& 15 \qquad ( 12 )$$

where the parameter stateTransTab specifies the state transition table:
if DQ is disabled, the value of stateTransTab is set equal to 0;
if 4-state DQ is used, the value of stateTransTab is 32-bit value and is set equal to 587280912 (binary number is (100011000000010011001000010000)₂);
if 8-state DQ is used, the value of stateTransTab is 64-bit value and is set equal to 6274468666787591456 (binary number is

$$\begin{matrix}( 1010111000100110110010000000010 \\ {01000110001100010111010100100000 )}_{2}\end{matrix} ) .$$

As proposed in the example above, if 16-state DQ is applied, then the value of stateTransTab is 128-bit value and is set equal to 254698168133397952884108689037962011200 (binary number is

$$\begin{matrix}( 10111111100111010001010100110111 \\ 10001100101011100010011011101010 \\ 11111011011100111101100101010001 \\ {11001000000001000110001001000000 )}_{2}\end{matrix} ) .$$

Note that if the number of states continue to increase (i.e. 2^{K}>16), Equation (12) might need to be modified. The decoding process is designed in a way that only the state transition table used depends on the selected variant of dependent quantization; other remaining aspects are the same for all versions of dependent quantization (4 states, 8 states and 2^{K}>8 states).

According to a second embodiment, the number of states used for DQ is based on the number of coded transform coefficients in block. In the ECM, the number of states for the state machine could either be 4 states or 8 states, based on a syntax element pic_dep_quant_enabled_idc in the slice level. pic_dep_quant_enabled_idc equal to 0 specifies that dependent quantization is disabled for slices. pic_dep_quant_enabled_idc equal to 1 specifies that dependent quantization with 4 states is used for all transform blocks in slices. pic_dep_quant_enabled_flag equal to 2 specifies that dependent quantization with 8 states is used for all transform blocks in slices.

As aforementioned, for some transform blocks with long reconstructed transform coefficients, the packing density of the trellis-coded quantization in the high-dimensional signal space could be achieved with the increased number of states; while for some transform blocks only containing a small number of reconstructed transform coefficients, the simplest DQ design with 4 states could be enough. The DQ design with fixed number of states for all the transform blocks in the same slice might be penalizing in terms of compression efficiency and complexity.

The second embodiment proposed in this application comprises deciding the number of DQ states used for a transform block based on the number of coded transform coefficients in this transform block. As known by the skilled in the art, the coefficients are inferred as 0 if their scanning positions are before the last significant coefficient, that is only the coefficients from the last significant coefficient need to be coded wherein a significant coefficient is a non-zero transform coefficient. Therefore, the coded transform coefficients and the inferred zero coefficients form the coefficients of the transform block. In a variant, a number of coded transform coefficients N in a transform block satisfies (e.g., is less than, is greater than, equals, etc.) a specific number (a.k.a. threshold value T), DQ with a first number of states S1 (typically 4) is selected for this transform block, otherwise DQ with another number of states S2 (typically 2^{K}>4) is selected.

In another variant of the second embodiment, in terms of improving compression efficiency, the number of DQ states used for a transform block increases as the number of coded transform coefficients increasing. In another variant embodiment, if the goal is to reduce complexity, the number of DQ states used for a transform block decreases as the number of coded transform coefficients in the block increasing.

In yet another variant, DQ could also be disabled if the numbers of coded transform coefficients are very few, or/and very large. As previously explained, this embodiment corresponds to a particular case with one-state quantization using two scalar quantizers. As for the current selection at slice level based on a syntax element pic_dep_quant_enabled_idc, the selection is done at the transform block level among dependent quantization is disabled the transform block, dependent quantization with 4 states is used for the transform block, dependent quantization with 8 states is used for the transform block.

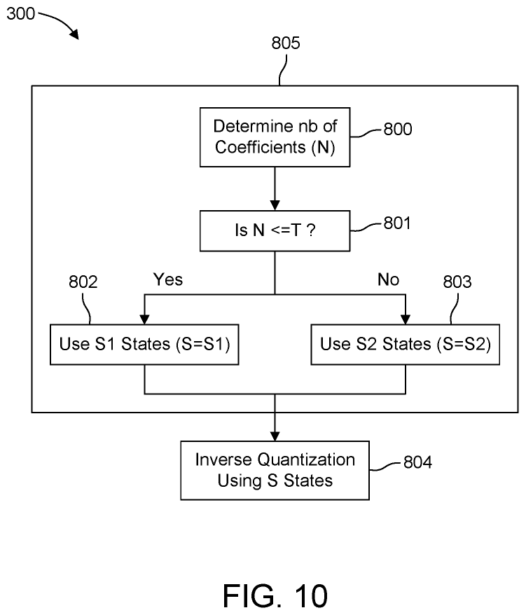

FIG. 10 illustrates a decoding method 300 according to a general aspect of the second embodiment. The step 805 of determining a number of states in a DQ is based on an indicator of a number of coded coefficients in the block of coefficients. In step 800, the number of coded transform coefficients N is determined. In step 801, this number is compared to a value T. If N is lower than or equal to T, the number of states S is set to S1. Otherwise, S set to S2. In step 804, the transform coefficients are inverse quantized using S states. The same process applies at the encoder, but in step 804, the transform coefficients are quantized using S states, instead of being inverse quantized.

In the residual coding for transform coefficients, a diagonal scan converts a 2-D block into a 1-D array and defines a processing order for the transform coefficients. Coding order starts at the last significant coefficient in a block and proceeds to the DC coefficient. The location of the last significant coefficient is signaled to reduce the number of coded bins by saving the explicit coding of trailing zeros toward the end of a forward scan. In the VVC/ECM, all quantization indexes that precede a signaled last significant coefficient location in coding order are inferred to be equal to zero. Hereby, the number of transform coefficients N to code in a transform block can be presented by the scan position of the last significant coefficient (ScanPosLast) in a transform block, for example, N=ScanPosLast+1 (if the last significant coefficient is a DC coefficient, the scan position ScanPosLast equals to 0).

For example, the condition for using DQ with 2^{K}>4 states for a transform block may be that the number of transform coefficients N is larger than or equal to a value T, such as, but not limited to, 16 (equals to a 4×4 subblock). As shown in Table 6, the selection of the state transition table for a transform block would depend on the number of coded transform coefficients N in this transform block, which could be indicated as N=ScanPosLast+1. If the number of coded transform coefficients N is smaller than 16, DQ with 4 states is applied for this transform block where the 2D-array 4stateTransTable in Equation (6) is used. Otherwise, DQ with 8 states is used for this transform block, where the 2D-array 8stateTransTable in Equation (5) is used.

TABLE 6
The used variant of the state transition table for a
transform block is decided by ScanPosLast.

| | Descriptor |
|---|---|
| residual_coding( x0, y0, log2TbWidth, log2TbHeight, cldx ) { | |
| ... | |
| stateTab = ( ScanPosLast + 1 ) > 16 ? 8stateTransTable : 4stateTransTable | |
| ... | |

In some examples, the value of the threshold T may be pre-defined and fixed for all sequences, or be signaled in sequence parameter set (SPS)/view parameter set (VPS)/picture parameter set (PPS)/picture header.

In yet another variant of the second embodiment, more than two possible number of states are supported. For instance, three number of states, S1, S2, S3, can be selected depending on the number of coded coefficients. For example, there could be several thresholds used as the conditions for adjusting the number of states of the DQ in a transform block. The number of state transition tables may be configured to K candidates for a transform block is given as follows:

$$\{ \begin{matrix}s t a t e T a b = 0 if ( ScanPosLast + 1 ) < {T}_{1} \\ s t a t e T a b = 4 stateTransTable if {T}_{1} \leq ( S c a n P o s L a s t + 1 ) < {T}_{2} \\ s t a t e T a b = 8 stateTransTable if {T}_{2} \leq ( S c a n P o s L a s t + 1 ) < {T}_{3} \\ … \\ s t a t e T a b = {2}^{K} stateTransTable if {T}_{K - 1} \leq ( S c a n P o s L a s t + 1 )\end{matrix} \qquad ( 13 )$$

For example, each transform block could select one among K=3 possible state transition tables. In this case, K−1=2 thresholds are denoted: a first threshold T₁ can be defined as, such as, but not limited to, 2 (only one transform coefficient is available in the block); a second threshold T₂ can be set as, such as, but not limited to, 16 (only transform coefficients in the first sub-block are available). As depicted in Table 7, if the number of coded transform coefficients N equal to 1, where only DC coefficient is available in the block, it specifies that DQ is disabled for this transform block (stateTab=0). The selection process for the remaining possible state transition tables keeps the same as Table 6.

TABLE 7
The DQ usage and the used variant of the state transition table
for a transform block is decided by ScanPosLast.

| | Descriptor |
|---|---|
| residual_coding( x0, y0, log2TbWidth, log2TbHeight, cldx ) { | |
| ... | |
| stateTab = ( ScanPosLast + 1 ) < 2 ? 0 : ( ( ScanPosLast + 1 ) < 16 ? | |
| 4stateTransTable : 8stateTransTable ) | |
| ... | |

Accordingly, the number of states used in the dependent quantization is determined based on whether the number of coded coefficients in the block of coefficients is within a range of values as for instance [0, T₁], [T₁, T₂], [t₂, 16].

In some examples, DQ with 2^{K}>8 states, as disclosed with the first embodiment, could also be an option for a transform block if K>3 state transition tables are needed. The number of thresholds K−1 may be pre-defined and fixed for all sequences, or be signaled in SPS/VPS/PPS/picture header. Alternatively, the number of thresholds K−1 may be dependent on the block size, e.g., width and/or height of the current block.

According to a third embodiment, the number of states used in the dependent quantization is based on a size of the block of coefficients. As previously explained, the available reconstructed transform coefficients are packed in the N-dimensional vector space in DQ. To maximize the coding efficiency, the vector space of the trellis-coded quantization needs to be packed denser. For vector space with larger dimensions, the packing density can be achieved by increasing the number of states used for DQ. Therefore, the number of DQ states used for a transform block based on the number of transform coefficients is proposed in the first embodiment. However, the number of transform coefficients in a block could normally be related to the size of block.

The step 801 of FIG. 10 can be based on other criteria than the number of coded coefficients. Various embodiments can be derived from this concept, by checking in step 801 using other features rather than the number of coded transform coefficients.

The third embodiment proposed in this application comprises determining the number of DQ states used for a transform block based on the block size. Such that the block size, e.g., width and/or height of the current block, satisfies (e.g., is less than, is greater than, equals, etc.) a specific number (a.k.a. threshold T), DQ with 4 states would be selected for this transform block, otherwise DQ with 2^{K}>4 states would be applied.

In a variant of the third embodiment, in terms of improving compression efficiency, the number of DQ states used for a transform block increases as the block size increasing. In another variant, if the goal is to reduce complexity, the number of DQ states used for a transform block decreases as the block size increasing.

In yet another variant, DQ could also be disabled if the block sizes are very small, or/and very large.

For example, the condition for using DQ with 2^{K}>4 states for a transform block may be that both the width and the height of the current block are larger than a threshold T, such as, but not limited to, 4 (which starts from 8×8 block). As shown in Table 8, the selection of the state transition table for a transform block would depend on the size of this transform block, where both the logarithm of the width and the logarithm of the height to base 2 (log2TbWidth and log2TbHeight) of the current block are taken into consideration. If both the log2TbWidth and log2TbHeight are larger than 2 (where the width and the height are larger than 4), DQ with 8 states is used for this transform block, where the 2D-array 8stateTransTable in Equation (5) is used. Otherwise, DQ with 4 states is applied for this transform block where the 2D-array 4stateTransTable in Equation (6) is used.

TABLE 8
The used variant of the state transition table for a
transform block is decided by the block size.

| | Descriptor |
|---|---|
| residual_coding( x0, y0, log2TbWidth, log2TbHeight, cldx ) { | |
| ... | |
| stateTab = (log2TbWidth > 2 && log2TbHeight > 2 ) ? 8stateTransTable : | |
| 4stateTransTable | |
| . . . | |

In some examples, the value of this threshold T may be pre-defined and fixed for all sequences, or be signaled in SPS/VPS/PPS/picture header.

Additionally, there could be two different thresholds defined for the width and the height of the block, separately. Moreover, there could also be several thresholds or threshold pairs used as the conditions for adjusting the number of states of the DQ in a transform block. The number of thresholds may be pre-defined and fixed for all sequences, or be signaled in SPS/VPS/PPS/picture header.

In some examples, DQ with 2^{K}>8 states, as in the first embodiment, could also be an option for a transform block if several state transition tables are needed. Alternatively, DQ with 2^{K}>8 states could replace current 4-state or/and 8-state variants based on the block size, e.g., width and/or height of the current block.

According to a fourth embodiment, the number of states used in the dependent quantization is based on the block prediction mode among inter prediction and intra prediction. Normally inter predicted blocks have sparser residue than intra predicted blocks, since inter prediction is typically more accurate.

The fourth embodiment proposed in this application comprises determining the number of DQ states used for a transform block based on the block prediction mode. Accordingly, if the block is inter predicted, DQ with 4 states would be selected for this transform block, otherwise DQ with 2^{K}>4 states would be selected.

In terms of improving compression efficiency, the number of DQ states used for a transform block increases as the block is intra-predicted. If the goal is to reduce complexity, the number of DQ states used for a transform block decreases as the block is intra-predicted.

In yet another variant, DQ could also be disabled if block is intra-predicted, or intra-predicted.

For example, the condition for using DQ with 2^{K}>4 states for a transform block may be that the prediction mode of the current block is intra prediction. As shown in Table 9, the selection of the state transition table for a transform block would depend on the prediction mode of this coding block, which is indicated by a Boolean function isIntra(cu). If the isIntra(cu) function returns a TRUE value, which specifies the current coding block is intra-predicted, DQ with 8 states is used for this transform block, where the 2D-array 8stateTransTable in Equation (5) is used. Otherwise, DQ with 4 states is applied for this transform block where the 2D-array 4stateTransTable in Equation (6) is used.

TABLE 9
The used variant of the state transition table for a
transform block is decided by the block prediction mode.

| | Descriptor |
|---|---|
| residual_coding( x0, y0, log2TbWidth, log2TbHeight, cldx ) { | |
| ... | |
| stateTab = isIntra(cu) ? 8stateTransTable : 4stateTransTable | |
| ... | |

In yet another variant of the fourth embodiment, when a block is intra-coded, the number of states can be based on the specific intra coding mode used for the block that contains the block. For instance the number of states can depend on whether the block is coded using Matrix-based Intra Prediction (MIP), directional intra prediction mode, non-directional prediction mode, Intra Sub-Partitions (ISP), Multiple Reference Line (MRL), Intra Block Copy (IBC), Palette.

In yet another variant of the fourth embodiment, when a block is inter-coded, the number of states can be based on the specific inter coding mode used for the block that contains the block. For instance, the number of states can depend on whether the block is coded using uni-/bi-prediction, Combined Inter/Intra Prediction (CIIP), Geometric Partitioning Mode (GPM), Affine or non-Affine, Local Illumination Compensation (LIC).

Additionally, the selection of the state transition table could be decided by the block prediction mode combining with other conditions related to the number of transform coefficients, as proposed with previous embodiments.

According to a fifth embodiment, the number of states used in the dependent quantization is based on a color component index specifying the color component among luma or chroma. The human visual system is less sensitive to color than it is to structure and texture information. Therefore, in many application scenarios, it is more important to provide a high resolution luma component than to provide such detail for the chroma components. During the video compression, reducing the data loss of luma samples is more necessary compared to the chroma samples. To mitigate the information loss, fine and accurate quantization for luma component is very essential.

The fifth embodiment proposed in this application comprises determining the number of DQ states based on the color components. Accordingly, for chroma components, DQ with 4 states would be selected; while for luma component DQ with 2^{K}>4 states would be selected.

In another variant, DQ could also be disabled for chroma components, or luma component.

For example, the condition for using DQ with 2^{K}>4 states may be when the luma component of a block is processed. As shown in Table 10, the selection of the state transition table would depend on the color component, which is indicated by a variable cIdx=0 . . . 2. cIdx equal to 0 specifies that the luma component of the current block is processed, and then DQ with 8 states is applied, where the 2D-array 8stateTransTable in Equation (5) is used. cIdx larger than 0 specifies that the chroma components of the current block is processed, and then DQ with 4 states is applied, where the 2D-array 4stateTransTable in Equation (6) is used.

TABLE 10
The used variant of the state transition table is
decided by the color components.

| | Descriptor |
|---|---|
| residual_coding( x0, y0, log2TbWidth, log2TbHeight, cldx ) { | |
| ... | |
| stateTab = cldx ? 4stateTransTable : 8stateTransTable | |
| ... | |

Additionally, the selection of the state transition table could be decided by the color components combining with other conditions related to the number of transform coefficients, as proposed other embodiments.

According to a sixth embodiment, the number of states used in the dependent quantization is based on a quantization parameter. In the VVC and the ECM, Quantization Parameter (QP) is a variable used for scaling of transform coefficient levels. The QP range starts from 0 to 63.

Commonly, high QPs correspond to coarse quantization, where most of the transform coefficients are quantized to zero; low QPs correspond to fine quantization, where a block could contain more non-zero transform coefficients than high QPs. Hence, the QP could impact the number of transform coefficients in a block.

The initial value of QP is signaled in PPS, and could be updated by a QP delta value in the slice segment header, and further refined by a potential CU-level QP delta. CU-level QP delta values for luma and chroma components can be signaled separately. For chroma components, a QP offset is specified for increasing the QP parameter range. To simplify the description, the initial QP in PPS can be indicated as qP, the slice-level QP is indicated as qP_{stice}, the final luma QP used for a transform block can be represented by qP_{γ}, and final chroma QP is represented by qP_{Cx}.

The sixth embodiment proposed in this application comprises determining the number of DQ states used for a transform block based on the quantization parameter. For instance, if the quantization parameter, e.g., the initial QP in PPS qP/or the slice-level QP qP_{stice}/or the final CU-level QP qP_{γ} and qP_{Cx}, satisfies (e.g., is less than, is greater than, equals, etc.) a specific number (a.k.a. threshold T), DQ with 4 states would be selected for this transform block, otherwise DQ with 2^{K}>4 states would be selected.

In terms of improving compression efficiency, the number of DQ states used for a transform block increases as the quantization parameter decreasing. If the goal is to reduce complexity, the number of DQ states used for a transform block decreases as the quantization parameter decreasing.

In yet another variant, DQ could also be disabled if the values of QP are very small, or/and very large.

For example, the condition for using DQ with 2^{K}>4 states for a transform block may be that final luma/chroma QP used for a transform block is smaller than a threshold value T, such as, but not limited to, 32 (which equals media value of the QP range). As shown in Table 11, the selection of the state transition table for a transform block would depend on the QP of this transform block, where the final luma qP_{γ} or the final chroma qP_{Cx} would be used based on the color components cIdx. If luma component is being processed (cIdx=0) and qP_{γ} is smaller than 32 (lower QP, finer quantization), DQ with 8 states is used for this transform block, where the 2D-array 8stateTransTable in Equation (5) is used. Otherwise, DQ with 4 states is applied for this transform block where the 2D-array 4stateTransTable in Equation (6) is used. Similar process can be derived for chroma components.

TABLE 11
The used variant of the state transition table is decided by the quantization parameters.

| | Descriptor |
|---|---|
| residual_coding( x0, y0, log2TbWidth, log2TbHeight, cldx ) { | |
| ... | |
| stateTab = ( cldx ? qP_{cx} : qP_{Y} ) < 32 ? 8stateTransTable : 4stateTransTable | |
| ... | |

In some examples, the value of the threshold T may be pre-defined and fixed for all sequences, or be signaled in SPS/VPS/PPS/picture header.

Additionally, there could be two different thresholds defined for the final luma QP and the final chroma QP, separately. Moreover, there could also be several thresholds or threshold pairs for the final luma/chroma QP used as the conditions for adjusting the number of states of the DQ in a transform block. The number of thresholds may be pre-defined and fixed for all sequences, or be signaled in SPS/VPS/PPS/picture header.

Additionally, a threshold or several thresholds could be defined for the QP in PPS qP, or the slice-level QP qP_{stice}. The value(s) of a threshold or several thresholds, and/or the number of thresholds may be pre-defined and fixed for all sequences, or be signaled in SPS/VPS/PPS/picture header.

Additionally, the selection of the state transition table could be decided by the quantization parameter combining with other conditions related to the number of transform coefficients, as proposed in any of the previous embodiments.

According to a seventh embodiment, the number of states used in the dependent quantization is based on the transform processes, such as a transform type and/or a transform size. Indeed, the transform block can be coded/decoded using different transform processes. For example, in the VVC, a block can use different horizontal/vertical transforms, called Multiple Transform selection (MTS). It can also use a secondary transform named Low Frequency Non Separable Transform (LFNST). It can also be coded using Sub-Block Transform (SBT).

In a variant of the seventh embodiment, the number of states can be selected depending on the types of transforms using for performing the transform/inverse transform of the block.

In yet another variant, DQ could also be disabled for one or some transform types of the block.

In yet another variant, the number of states can be selected depending on whether the DCT-II is used or not for the block.

In yet another variant, the number of states can be selected depending on whether the DCT-VIII is used or not for the block.

In yet another variant, the number of states can be selected depending on whether the DST-VII is used or not for the block.

In yet another variant, the number of states can be selected depending on activation or not of MTS for the block.

In yet another variant, the number of states can be selected depending on activation or not of LFNST for the block.

In yet another variant, the number of states can be selected depending on whether the SBT mode is used or not for the block.

Additionally, the selection of the state transition table could be decided by the quantization parameter combining with other conditions related to the number of transform coefficients, as proposed in any of the previous embodiments.

### Additional Embodiments and Information

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the quantization, entropy coding, inverse quantization and entropy decoding modules (230, 245, 240, 330, 340), of a video encoder 200 and decoder 300 as shown in FIG. 2 and FIG. 3. Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination. Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

Note that the syntax elements as used herein are descriptive terms. As such, they do not preclude the use of other syntax element names.

The implementations and aspects described herein may be implemented as various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
SDP (session description protocol), a format for describing multimedia communication sessions for the purposes of session announcement and session invitation, for example as described in RFCs and used in conjunction with RTP (Real-time Transport Protocol) transmission;
DASH MPD (Media Presentation Description) Descriptors, for example as used in DASH and transmitted over HTTP, a Descriptor is associated to a Representation or collection of Representations to provide additional characteristic to the content Representation;
RTP header extensions, for example as used during RTP streaming;
ISO Base Media File Format, for example as used in OMAF and using boxes which are object-oriented building blocks defined by a unique type identifier and length also known as ‘atoms’ in some specifications;
HLS (HTTP live Streaming) manifest transmitted over HTTP. A manifest can be associated, for example, to a version or collection of versions of a content to provide characteristics of the version or collection of versions.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for video decoding, the method comprising:
determining a number of states used in a dependent quantization for a block of quantized coefficients; and
obtaining a block of coefficients by applying an inverse dependent quantization with the determined number of states to the block of quantized coefficients.

2. The method of claim 1, wherein the number of states used in the dependent quantization is one of 1, 4 or 2^{K} with K being a positive integer larger than 2.

3. (canceled)

4. The method of claim 1, wherein the number of states used in the dependent quantization is based on an indicator of a scan position of a last significant coefficient in the block of coefficients.

5-8. (canceled)

9. The method of claim 1, wherein the number of states used in the dependent quantization is based on at least one of an intra prediction mode or inter prediction mode.

10-11. (canceled)

12. The method of claim 1, wherein the number of states used in the dependent quantization is based on a quantization parameter.

13. (canceled)

14. The method of claim 1, wherein the number of states used in the dependent quantization is based on a size of transform.

15. (canceled)

16. A method for video encoding, the method comprising:
determining a number of states used in a dependent quantization for a block of coefficients; and
obtaining a block of quantized coefficients by applying the dependent quantization with the determined number of states to the block of coefficients.

17. The method of claim 16, wherein the number of states used in the dependent quantization is one of 1, 4 or 2^{K}, K being a positive integer larger than 2.

18. (canceled)

19. The method of claim 16, wherein the number of states used in the dependent quantization is based on an indicator of a scan position of a last significant coefficient in the block of coefficients.

20-23. (canceled)

24. The method of claim 16, wherein the number of states used in the dependent quantization is based on at least one of an intra prediction mode or inter prediction mode.

25-26. (canceled)

27. The method of claim 16, wherein the number of states used in the dependent quantization is based on a quantization parameter.

28. (canceled)

29. The method of claim 16, wherein the number of states used in the dependent quantization is based on a size of transform.

30. (canceled)

31. An apparatus for video decoding, the apparatus comprising one or more processors, and at least one memory and wherein the one or more processors is configured to:
determine a number of states used in a dependent quantization for a block of quantized coefficients; and
obtain a block of coefficients based on an inverse dependent quantization with the determined number of states applied to the block of quantized coefficients.

32. An apparatus for video encoding, the apparatus comprising one or more processors, and at least one memory and wherein the one or more processors is configured to:
determine a number of states used in a dependent quantization for a block of coefficients; and
obtain a block of quantized coefficients by applying the dependent quantization with the determined number of states to the block of coefficients.

33. (canceled)

34. The apparatus of claim 31, wherein the number of states used in the dependent quantization is one of 1, 4 or 2^{K} with K being a positive integer larger than 2.

35. The apparatus of claim 31, wherein the number of states used in the dependent quantization is based on an indicator of a scan position of a last significant coefficient in the block of coefficients.

36. The apparatus of claim 31, wherein the number of states used in the dependent quantization is based on at least one of an intra prediction mode or inter prediction mode.

37. The apparatus of claim 31, wherein the number of states used in the dependent quantization is based on a quantization parameter.

38. The apparatus of claim 31, wherein the number of states used in the dependent quantization is based on a size of transform.

39. The apparatus of claim 32, wherein the number of states used in the dependent quantization is one of 1, 4 or 2^{K} with K being a positive integer larger than 2.

40. The apparatus of claim 32, wherein the number of states used in the dependent quantization is based on an indicator of a scan position of a last significant coefficient in the block of coefficients.

41. The apparatus of claim 32, wherein the number of states used in the dependent quantization is based on at least one of an intra prediction mode or inter prediction mode.

42. The apparatus of claim 32, wherein the number of states used in the dependent quantization is based on a quantization parameter.

43. The apparatus of claim 32, wherein the number of states used in the dependent quantization is based on a size of transform.
